(19) United States
(12) Patent Application Publication
(10) Pub. No.: US 2025/0162690 A1
(43) Pub. Date: May 22, 2025

(54) NON-SLIP COVER

(71) Applicant: SewLong LLC, South Salt Lake, UT (US)

(72) Inventor: Justin L. Jones, Holladay, UT (US)

(21) Appl. No.: 18/812,002

(22) Filed: Aug. 22, 2024

Related U.S. Application Data
(60) Provisional application No. 63/601,089, filed on Nov. 20, 2023.

(51) Int. Cl. B63B 17/02; B32B 3/08; B32B 5/02; B32B 5/26; B32B 7/09; B32B 25/10; B32B 27/12; B32B 27/28

(52) U.S. Cl. CPC B63B 17/02; B32B 3/08; B32B 5/02; B32B 5/26; B32B 7/09; B32B 25/10; B32B 27/12; B32B 27/283; B32B 2307/51; B32B 2307/724; B32B 2307/7265; B32B 2307/744; B32B 2605/12

(57) ABSTRACT

Covers including non-slip materials for preventing damage to objects covered by the covers are disclosed herein. A boat cover includes a first fabric material and a second material coupled to the first fabric material. The first fabric material defines an exterior surface of the boat cover and at least partially defines an interior surface of the boat cover. The second material is a non-slip material different from the first fabric material. The second material extends at least partially around a perimeter of the first fabric material and at least partially defines the interior surface of the boat cover.

### CROSS-REFERENCE TO RELATED APPLICATION(S)

This application claims priority to U.S. Provisional Application No. 63/601,089, filed 20 Nov. 2023, the disclosure of which is incorporated herein by reference in its entirety.

### FIELD

The present disclosure relates generally to covers. More particularly, the present disclosure is directed to covers that are formed from fabrics that include non-slip materials on portions of inner surfaces thereof.

### BACKGROUND

Covers are widely used in transportation to protect valuable cargo, such as boats, other personal watercraft, automobiles, travel trailers, recreational vehicles, bicycles, and the like from weather, wind-blown debris, road hazards, and the like. However, air flow during transportation has a tendency to cause covers to flap, vibrate, rub, or otherwise move relative to the cargo the covers are protecting, which can cause damage to the cargo. As a result, tie down devices such as straps, snaps, and buckles have been employed to secure covers over cargo, and soft materials such as fleece have been used to line covers in order to prevent damage to the cargo. However, covers can still flap, even when secured over cargo. Moreover, contaminants, such as sand, can be trapped in soft materials that line covers, and can damage the cargo. As such, a need exists for covers that do not flap or move relative to cargo on which the covers are installed.

### SUMMARY

In at least one example of the present disclosure, a boat cover can include a first fabric material defining an exterior surface of a boat cover and a second material coupled to the first fabric material. The first fabric material can at least partially define an interior surface of the boat cover. The second material can be a non-slip material different from the first fabric material. The second material can extend at least partially around a perimeter of the first fabric material. The second material can at least partially define the interior surface of the boat cover.

In some examples, the second material can include rubber or silicone. In some examples, the second material can be coupled to the first fabric material by sewing, bonding, or an adhesive. In some examples, the first fabric material can include a water resistant, breathable material.

In some examples, the second material can be discontinuous around the perimeter of the first fabric material. In some examples, the second material can be continuous around the perimeter of the first fabric material.

In some examples, the first fabric material can define a corner region and an edge region adjacent to the corner region. The corner region can be free from the second material. The second material can extend along the edge region.

In some examples, the boat cover can further include a third material coupled to the first fabric material. The third material can include a soft material different from the first fabric material and the second material. The third material can at least partially define the interior surface of the boat cover.

In some examples, the boat cover can further include a vent disposed in the first fabric material. The vent can be operable to create a pressure differential between an interior and an exterior of the boat cover when air moves over the boat cover.

In some examples, the boat cover can further include an elastic material coupled to the first fabric material. The elastic material can extend at least partially around a perimeter of the first fabric material. In some examples, the boat cover can further include a strap coupled to the first fabric material. The strap can be configured to apply pressure from the first fabric material to the second material.

In at least one example of the present disclosure, a cover can include a first fabric material defining an outer surface of a cover and a second material bonded to the first fabric material. The first fabric material can include a waterproof, breathable material. The second material can include a non-slip material. The second material can at least partially define an inner surface of the cover. The second material can at least partially surround the first fabric material on the inner surface of the cover.

In some examples, the second material can be bonded to the first fabric material by an adhesive or a bonding agent. In some examples, the second material can include silicone or rubber.

In some examples, the cover can further include a third material coupled to the first fabric material. The third material can at least partially define the inner surface of the cover. The third material can include fleece, flocking, felt, or flannel.

In some examples, the second material can extend continuously or discontinuously along a perimeter of the first fabric material.

In at least one example of the present disclosure, an accessory for a cover can include a first material configured to contact a boat and a second material bonded to the first material. The second material can be configured to contact a boat cover. The first material can include a non-slip material. The second material can include a breathable, waterproof material.

In some examples, the first material and the second material form an annular shape. In some examples, the first material can include a silicone or rubber material. The second material can include a fabric formed from polyester, acrylic, or nylon.

In some examples, the accessory can further include a third material bonded to the second material opposite the first material. The first material can be a first non-slip material. The third material can be configured to contact the boat cover. The third material can include a second non-slip material.

Features from any of the above-mentioned examples may be used in combination with one another in accordance with the general principles described herein. These and other examples, features, and advantages will be more fully understood upon reading the following detailed description in conjunction with the accompanying drawings and claims.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a side view of a boat cover installed on a boat.

FIG. 1B shows a top-down view of a boat cover installed on a boat.

FIG. 2 shows a side view of a boat cover installed on a boat.

FIG. 3 shows a top-down view of a boat cover installed on a boat.

FIGS. 4A through 4D show various patterns for non-slip materials applied to fabric materials of boat covers.

FIGS. 5A and 5B show side views of a cover accessory and a boat cover installed on a boat.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to covers that can be used to protect objects. More particularly, the present disclosure relates to covers that can be used to protect objects during transportation, in areas in which the covers and objects are subjected to wind, and the like. The present disclosure is primarily discussed in the context of boat covers, which can be used while transporting boats; however, the teachings of the present disclosure can be applied to any covers, such as covers used to protect other personal watercraft, automobiles, travel trailers, recreational vehicles, bicycles, other vehicles, air conditioner units, grills, fire pits, hot tubs, other personal items, or any other objects. The covers of the present disclosure can be particularly useful in covering objects in situations where the covers and objects are subjected to windy conditions, such as during transportation of the objects, or in areas with high winds.

An object can be covered with a cover in order to protect the object from weather, wind-blown debris, and the like. Wind that blows across the covered object can cause the cover to flap, vibrate, rub, or otherwise move relative to the object, which can cause damage to the object. As such, there is a need for covers that do not move relative to objects that they cover, especially when subjected to wind.

In particular examples of the present disclosure, a cover can include a first fabric material and a non-slip material coupled to the first fabric material. The first fabric material can include a water-resistant, breathable material that can be used to protect an object to be covered from weather. The non-slip material can be provided along portions of the first fabric material that are prone to flapping, vibrating, rubbing, or otherwise moving relative to the object. For example, the non-slip material can be provided along a perimeter of an inner surface of the first fabric material, along inner surfaces of straight edges of the first fabric material that are prone to moving due to wind, or the like. The non-slip material can include rubber materials, silicone materials, or the like. The non-slip material can interface between the first fabric material and the object in order to maintain the position of the first fabric material relative to the object and prevent any flapping, vibration, rubbing, or movement of the cover relative to the object. This prevents damage to the object caused by movement of the cover against the object.

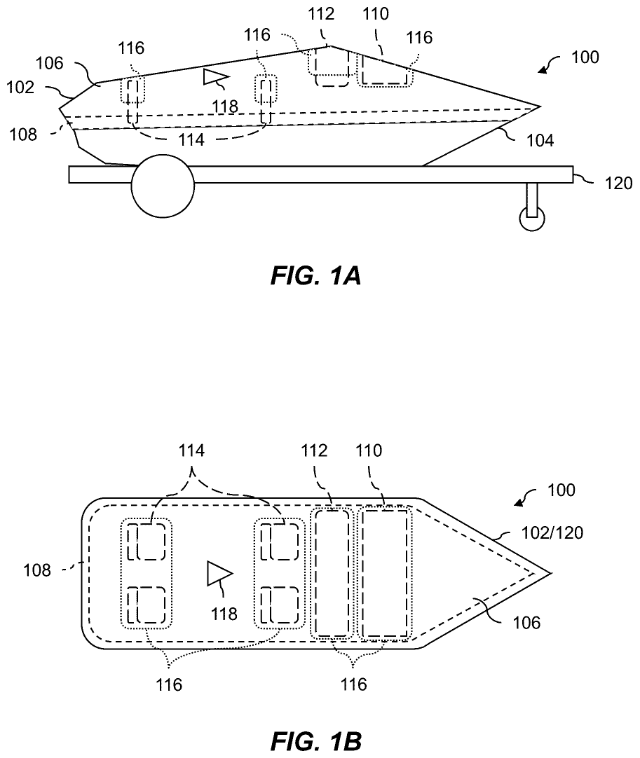

These and other embodiments are discussed below with reference to FIGS. 1A through 5. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A and 1B illustrate a side view and a top-down view, respectively, of a covered boat 100 that includes a cover 102 installed on a boat 104. The boat 104 can be loaded on a trailer 120 for transportation, storage, or the like. The cover 102 includes a first material 106 and a second material 108. The first material 106 can be a water-resistant or waterproof, breathable material, that is designed to protect the boat 104 from weather. The first material 106 can define an exterior surface (also referred to as an outer surface or the like) of the cover 102 and at least partially define an interior surface (also referred to as an inner surface, an inside surface, or the like) of the cover 102. The second material 108 can be a non-slip material that coupled to the first material 106 between the first material 106 and the boat 104. The second material 108 can at least partially define the interior surface of the cover 102. The second material 108 can be formed from a non-slip material that grips the boat 104. As such, the second material 108 retains the cover 102 in a desired position relative to the boat 104, even as the boat 104 is transported, subjected to wind forces, and the like. This prevents the cover 102 from flapping, rubbing, or otherwise moving relative to the boat 104, and prevents the cover 102 from damaging the boat 104.

In the example illustrated in FIGS. 1A and 1B, the second material 108 is coupled to the first material 106 around a perimeter of the cover 102. The second material 108 and the first material 106 define at least portions of the interior surface of the cover 102, and the second material 108 encircles or surrounds the first material 106 on the interior surface of the cover 102. In the example of FIGS. 1A and 1B, the second material 108 extends continuously around a perimeter of the cover 102. Providing the second material 108 along a perimeter of the cover 102 can provide improved grip between the cover 102 and the boat 104, preventing the cover 102 from flapping, rubbing, or otherwise moving relative to the boat 104, and preventing the cover 102 from damaging the boat 104. Moreover, forming at least a portion of the interior surface of the cover 102 from the first material 106, without any additional materials coupled thereto, allows for the cover 102 to maintain good breathability, which prevents mold and mildew from forming inside the cover 102.

In some examples, the second material 108 can be coupled to the first material 106 in any positions along the cover 102 that would contact the boat 104. For example, the second material 108 can be provided along portions of the cover 102 that will contact a hull of the boat 104, a windshield 110 of the boat 104, a tower 112 of the boat 104, seats 114 of the boat 104, any combination thereof, or in any other positions that will contact the boat 104. In some examples, the second material 108 can be coupled to the first material 106 in positions along the cover 102 that are most likely to experience flapping, rubbing, or other movement. For example, portions of the cover 102 that are disposed adjacent to corners or radiuses of the boat 104 (referred to as corner regions of the cover 102) can have increased tension relative to portions of the cover 102 that are disposed adjacent to relatively straight portions of the boat 104 (referred to as edge regions of the cover 102). Because of the tension in the corner regions of the cover 102, the cover 102 may be unlikely to flap in the corner regions, while the cover 102 is likely to flap in the edge regions. As such, the second material 108 can be provided in the edge regions and omitted from the corner regions, which can reduce manufacturing costs for the cover 102. Providing the second material 108 at any desired positions along the cover 102 can provide improved grip between the cover 102 and the boat 104, preventing the cover 102 from flapping, rubbing, or otherwise moving relative to the boat 104, and preventing the cover 102 from damaging the boat 104.

The cover 102 can be secured to the boat 104 by various methods. For example, at least portions of a perimeter of the cover 102 can include elastic materials, which can be used to secure the cover 102 to the boat 104. In some examples, the elastic materials can be used in addition to other securing mechanisms, and can be used to aid in positioning the cover 102 relative to the boat 104. The cover 102 can include ratchets, straps, snap fasteners, mounts therefore, combinations thereof, or the like. In examples in which the cover 102 is secured to the boat 104 by ratchets or straps, tension from the ratchets or straps can be applied through the first material 106 to the second material 108 to further improve grip between the cover 102 and the boat 104. In examples in which the cover 102 is secured to the boat 104 by snap fasteners, the second material 108 can extend between adjacent ones of the snap fasteners, and can at least partially surround individual ones of the snap fasteners. Any suitable means can be used to secure the cover 102 to the boat 104, and including the second material 108 can improve the grip of the cover 102 to the boat 104 in combination with any means used to secure the cover 102 to the boat 104.

The first material 106 can be a fabric, textile, woven, or other suitable material. The first material 106 can be referred to as a weather-resistant layer, a weather-resistant fabric, or the like. The first material 106 can be waterproof or water-resistant, and can be breathable. Including the first material 106 in the cover 102 prevents water ingress through the cover 102 into the boat 104, while allowing water vapor to escape the cover 102. This prevents growth of mold and mildew inside the cover 102. In some examples, the first material 106 can include a woven fabric formed from polyester, acrylic, nylon, cotton, linen, PVC, polypropylene, other fibers or polymers, or the like. The first material 106 can be formed from coated or uncoated polymers or fibers, depending on desired properties of the first material 106. In some examples, the fibers or polymers of the first material 106 can be coated with PVC, PTFE, or the like.

The second material 108 can be a non-slip material. The second material 108 can be referred to as a non-slip layer, a grip layer, or the like. The second material 108 can be a fabric material, or a layer of material that is applied to the first material 106. The second material 108 can include rubber, silicone, PVC, hydrophobic compounds, or any other suitable materials that supply increased grip between the first material 106 and the boat 104. The second material 108 can be formed from materials that do not scratch the boat 104. The second material 108 can be coupled to the first material 106 through sewing, stitching, bonding, an adhesive, fusion, welding, coating, painting, or any other suitable means. The second material 108 can be directly coupled to the first material 106, or another material, such as an adhesive, a bonding agent, or the like can be interposed between the second material 108 and the first material 106.

In some examples, a third material 116 can also be coupled to the first material 106. The third material 116 can be a soft material that can be provided to protect surfaces of the boat 104 from contact with the cover 102. The third material 116 can be provided in any positions along the cover 102 that contact the boat 104 when the cover 102 is installed. For example, third material 116 can be provided along portions of the cover 102 that contact the windshield 110, the tower 112, the seats 114, any combination thereof, or in any other positions that contact the boat 104. The third material 116 can at least partially define the interior surface of the cover 102. The third material 116 can be encircled or surrounded, either wholly or partially, by the first material 106 and/or the second material 108.

In some examples, the third material 116 can be provided at positions on the cover 102 that experience some movement, even when the cover 102 is secured to the boat 104. For example, the second material 108 and any securing mechanisms that secure the cover 102 to the boat 104 may prevent movement of the cover 102 relative to the boat along a perimeter of the cover 102. However, interior portions of the cover 102, which may have less tension on them, may still experience some movement. This can include portions of the cover 102 adjacent to the windshield 110, the tower 112, the seats 114, and the like of the boat 104. The third material 116 can prevent the cover 102 from damaging the boat 104, even when portions of the cover 102 move relative to the boat 104.

The third material 116 can be formed from any relatively soft materials that can prevent damage to components of the boat 104, even as the cover 102 moves relative to the boat 104. For example, the third material 116 can be formed from fleece, flocking, felt, flannel, or any other relatively soft materials. The third material 116 can be coupled to the first material 106 by sewing, stitching, bonding, an adhesive, fusion, welding, or any other suitable means.

The cover 102 can further include a vent 118. The vent 118 can provide a passage in the cover 102 to fluidly couple an interior of the cover 102 with an exterior of the cover 102. In some examples, the vent 118 can include channels or passages that create a pressure differential between the interior of the cover 102 and the exterior of the cover 102 as the boat 104 is transported and wind blows over the cover 102. In other words, the vent 118 is operable to create a pressure differential between an interior of the boat 104 covered by the cover 102 and an exterior of the boat 104 and the cover 102. More specifically, the vent 118 can be used to provide a reduced pressure in the interior of the cover 102 relative to a pressure on the exterior of the cover 102. This can help to suction the cover 102 to the boat 104, further preventing rubbing, flapping, and other movement of the cover 102 relative to the boat 104. The vent 118 can also increase the breathability of the cover 102, which can reduce humidity in the cover 102 and prevent mold and mildew from growing inside the cover 102. The vent 118 can be positioned anywhere along the cover 102. In the example illustrated in FIGS. 1A and 1B, a longitudinal axis of the vent 118 is parallel to a longitudinal axis of the boat 104; however, the longitudinal axis of the vent 118 can be angled relative to the longitudinal axis of the boat 104.

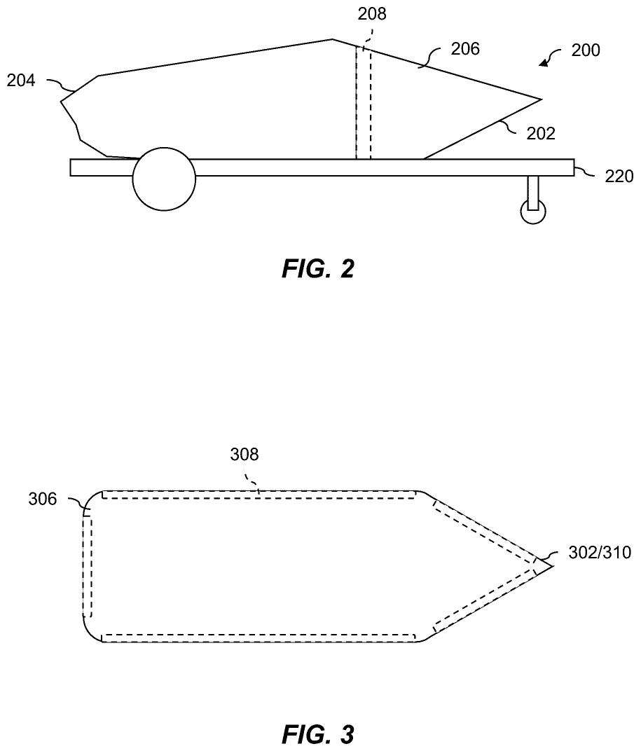

FIG. 2 illustrates a side view of a covered boat 200 that includes a cover 202 installed on a boat 204. The cover 202 can be installed on a foreword portion of the boat 204, and can be used to protect the boat 204 from road debris and the like during transportation of the boat 204. The boat 204 can be loaded on a trailer 220 for transportation, storage, or the like. The cover 202 includes a first material 206 and a second material 208. The first material 206 and the second material 208 can be the same as or similar to the first material 106 and the second material 108, discussed above with respect to FIGS. 1A and 1B.

The first material 206 can be a shock-resistant, water-resistant or waterproof material that is designed to protect the boat 204 from weather, wind-blown debris, road hazards, and the like. The first material 206 can define an exterior surface of the cover 202 and at least partially define an interior surface of the cover 202. The second material 208 can be a non-slip material that coupled to the first material 206 between the first material 206 and the boat 204. The second material 208 can at least partially define the interior surface of the cover 202. The second material 208 can be formed from a non-slip material that grips the boat 204. As such, the second material 208 retains the cover 202 in a desired position relative to the boat 204, even as the boat 204 is transported, subjected to wind forces, and the like. This prevents the cover 202 from flapping, rubbing, or otherwise moving relative to the boat 204, and prevents the cover 202 from damaging the boat 204.

In the example of FIG. 2, the cover 202 covers a front portion of the boat 204. The second material 208 can be coupled to the first material 206 in any desired positions along the cover 202. For example, as illustrated in FIG. 2, the second material 208 can be coupled to the first material 206 around a perimeter of the cover 202. The second material 208 and the first material 206 can each at least partially define portions of the interior surface of the cover 202, and the second material 208 can encircle or surround the first material 206 on the interior surface of the cover 202. In some examples, the second material 208 can be coupled to the first material 206 in any positions along the cover 202 that would contact the boat 204. For example, the second material 208 can be provided along portions of the cover 202 that will contact a hull, a windshield, seats, a tower, any combination thereof, or other portions of the boat 204. In some examples, the second material 208 can be coupled to the first material 206 in positions along the cover 202 that are most likely to experience flapping, rubbing, or other movement. Providing the second material 208 at any desired positions along the cover 202 can provide improved grip between the cover 202 and the boat 204, preventing the cover 202 from flapping, rubbing, or otherwise moving relative to the boat 204, and preventing the cover 202 from damaging the boat 204.

Providing the second material 208 in specific positions such that the first material 206 defines at least a portion of an interior surface of the cover 202 can reduce costs of manufacturing the cover 202. In some examples, the first material 206 can be formed from a breathable material, and defining at least a portion of the interior surface of the cover 202 with the first material 206 improves breathability of the cover 202, reducing mold and mildew growth between the cover 202 and the boat 204.

The cover 202 can be secured to the boat 204 by various methods. For example, the cover 202 can include ratchets, straps, snap fasteners, mounts therefore, elastic materials combinations thereof, or the like. Any of these securing mechanisms can be used to secure the cover 202 to the boat 204, and can be used to improve grip between the second material 208 and the boat 204.

In examples in which the cover 202 is provided on a front portion of the boat 204, the first material 206 may be formed from materials that are more shock-resistant and water-resistant, and less breathable relative to the first material 106. However, the first material 206 can be formed from the same or similar materials to the first material 106. The first material 206 can be a fabric, textile, woven, or other suitable material. The first material 206 can be referred to as a shock-resistant layer, a weather-resistant layer, a weather-resistant fabric, or the like. Including the first material 206 in the cover 202 prevents damage to the boat 204 from road hazards and the like, especially during transportation of the boat 204. In some examples, the first material 206 can include a woven fabric formed from neoprene, polyester, acrylic, nylon, cotton, linen, PVC, polypropylene, other fibers or polymers, or the like. The first material 206 can be formed from coated or uncoated polymers or fibers, depending on desired properties of the first material 206. In some examples, the fibers or polymers of the first material 206 can be coated with nylon, PVC, PTFE, or the like. In some examples, the first material 206 can include multiple layers of material.

Additional materials, such as materials the same as or similar to the third material 116 can be coupled to the first material 206, and can protect the boat 204 from damage caused by movement of the cover 202 relative to the boat 204. Breathability of the cover 202 may be relatively less important, and the interior surface of the cover 202 can be defined by the additional materials and the second material 208. In some examples, the interior surface of the cover 202 can be defined by the additional materials, the second material 208, and the first material 206. The additional materials can be provided at positions on the cover 202 that will be positioned adjacent to features of the boat 204 that are desired to be protected, such as adjacent to seats, a tower, a windshield, other components of the boat 204, and the like.

FIG. 3 illustrates a top-down view of a covered boat 300 that includes a cover 302 installed on a boat 304. The cover 302 can include a first material 306 and a second material 308, with the second material 308 being positioned to extend discontinuously along a perimeter of the cover 302. The boat 304 can be loaded on a trailer for transportation, storage, or the like. The first material 306 and the second material 308 can be the same as or similar to the first material 106 and the second material 108, discussed above with respect to FIGS. 1A and 1B.

In the example of FIG. 3, the second material 308 can be coupled to the first material 306 in positions along the cover 302 that are most likely to experience flapping, rubbing, or other movement. For example, portions of the cover 302 that are disposed adjacent to corners or radiuses of the boat 304 (referred to as corner regions of the cover 302) can have increased tension relative to portions of the cover 302 that are disposed adjacent to relatively straight portions of the boat 304 (referred to as edge regions of the cover 302). Because of the tension in the corner regions of the cover 302, the cover 302 may be unlikely to flap in the corner regions. In contrast, the edge regions have less tension, and the cover 302 may be likely to flap in the edge regions. As such, the second material 308 can be provided in the edge regions and omitted from the corner regions. In other words, the corner regions can be free from the second material 308. In the example of FIG. 3, the second material 308 is provided along a rear side (stern) of the boat 304, along opposite sides of the boat 304, and along opposite sides of a bow of the boat 304. The second material 308 can be provided at any of these locations, and any additional locations along the cover 302. Providing the second material 308 discontinuously around the perimeter of the cover 302 can reduce manufacturing costs for the cover 302, while still providing improved grip and reducing damage caused to the boat 304 by the cover 302 moving relative to the boat 304.

The second material 308 and/or additional materials, such as materials the same as or similar to the third material 116 can be coupled to the first material 306 at any other desired positions along the cover 302. For example, the second material 308 and/or the additional materials can be provided at positions on the cover 302 that will be positioned adjacent to features of the boat 304 that are desired to be protected, or that are likely to experience movement, such as adjacent to seats, a tower, a windshield, other components of the boat 304, and the like. This can further prevent damage to the boat 304, such as damage caused by the cover 302 moving relative to the boat 304.

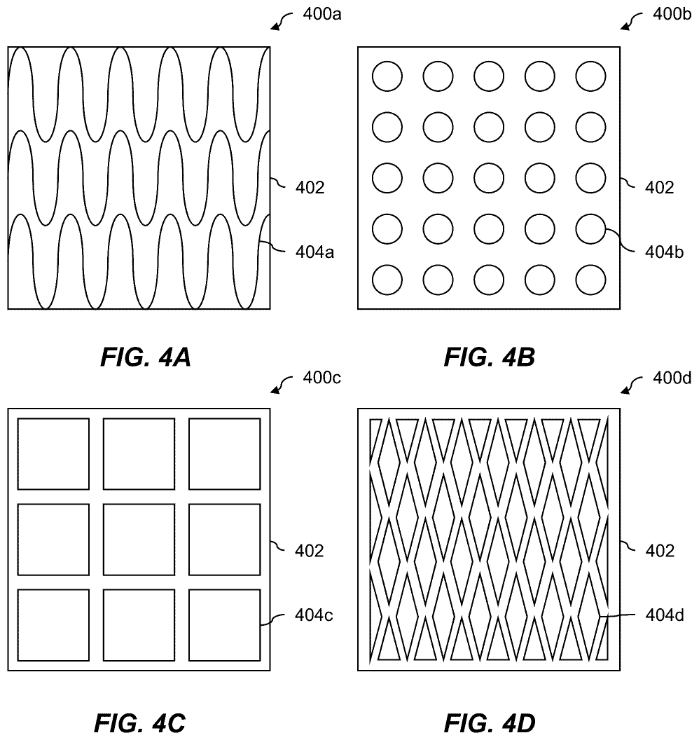

FIGS. 4A through 4D illustrate various patterns that can be used for the first materials and/or the second materials discussed above with respect to FIGS. 1A through 3. FIGS. 4A through 4D illustrate representative portions 400a-400d of covers that include a background 402 and a pattern 404a-404d. The material of the background 402 can be the first materials or the second materials. The material for the patterns 404a-404d can be the second materials. In other words, the representative portions 400a-400d can include backgrounds 402 and patterns 404a-404d formed from the second materials, or patterns 404a-404d formed from the second materials that are applied over backgrounds 402 formed from the first materials.

In FIG. 4A, the pattern 404a includes a wave pattern. The pattern 404a may include a zigzag pattern or other suitable pattern. In FIG. 4B, the pattern 404b includes a pattern of circles or dots. In FIG. 4C, the pattern 404c includes a pattern of squares or rectangles. In FIG. 4D, the pattern 404d includes a pattern of diamonds. Any other suitable patterns can be used for the representative portions 400a-400d of the covers, including other patterns of geometric shapes, and the patterns can be regular or irregular. The second materials can be applied to the covers using the patterns 404a-404d to increase breathability of the covers, allow water to drain out of the covers through the patterns 404a-404d, increase grip between the covers and boats on which the covers are installed, reduce costs and material requirements for the second materials, and the like.

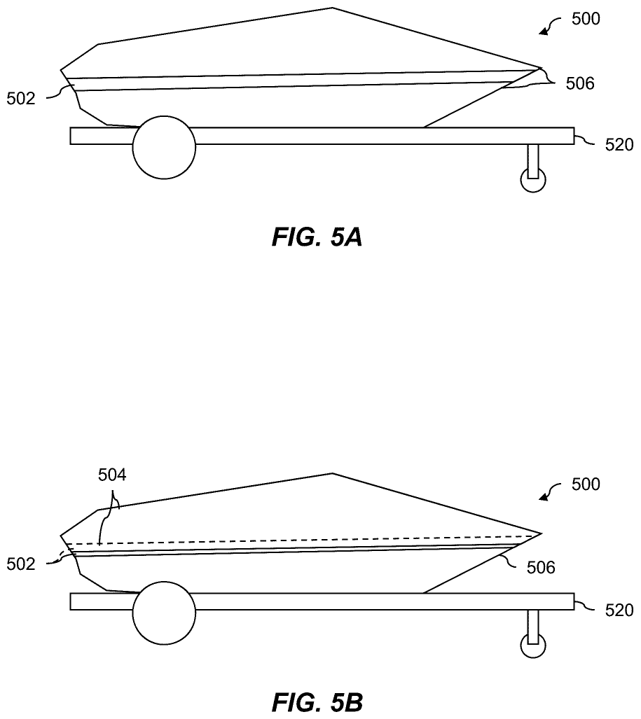

FIGS. 5A and 5B illustrate side views of a covered boat 500 that is covered with a cover accessory 502 and a cover 504, a method of installing the cover 504 on a boat 506 with the cover accessory 502. The boat 506 can be loaded on a trailer 520 for transportation, storage, or the like. The cover accessory 502 can include a second material (e.g., a non-slip material) alone, or a second material in combination with a first material (e.g., a water-resistant, breathable material). The cover 504 can include a first material, and can be a conventional cover. The cover accessory 502 can have an annular shape that extends around a perimeter of the boat 506. The first material and the second material can be the same as or similar to the first material 106 and the second material 108, discussed above with respect to FIGS. 1A and 1B.

In FIG. 5A, the cover accessory 502 is installed on the boat 506. As illustrated in FIG. 5A, the cover accessory 502 can have an annular shape that extends around a perimeter of the boat 506. The cover accessory 502 can include elastic materials or elastic portions that secure the cover accessory 502 on the boat 506. In some examples, the cover accessory 502 can include ratchets, straps, snap fasteners, mounts therefore, clastic materials combinations thereof, or the like. Any of these securing mechanisms can be used to secure the cover accessory 502 to the boat 506, and can be used to improve grip between the cover accessory 502 and the boat 506. In some examples, the cover accessory 502 can be secured to the boat 506 by securing mechanisms of the cover 504, which can include ratchets, straps, snap fasteners, mounts therefore, elastic materials combinations thereof, or the like.

The cover accessory 502 can include one or more layers of the second materials alone, or in combination with the first materials. For example, the cover accessory 502 can be formed primarily or completely from the second materials. The cover accessory 502 can be formed from a layer of the second materials coupled to a layer of the first materials. For example, the cover accessory 502 can include a layer of the second materials coupled to an interior surface of a layer of the first materials. An interior surface of the cover accessory 502 can be formed primarily or completely from the second materials and an exterior surface of the cover accessory 502 can be formed primarily or completely from the first materials. In some examples, the cover accessory 502 can be formed from multiple layers of the second materials coupled to a layer of the first materials. For example, the cover accessory 502 can include layers of the second materials coupled to interior and exterior surfaces of a layer of the first materials. Interior and exterior surfaces of the cover accessory 502 can be formed primarily or completely from the second materials, which can sandwich the first materials. The second materials can be included on an interior surface of the cover accessory 502 to increase grip between the cover accessory 502 and the boat 506. The second materials can be included on the exterior surface of the cover accessory 502 to increase grip between the cover accessory 502 and the cover 504. The second materials included on the interior surface and the exterior surface of the cover accessory 502 can be the same or different non-slip materials. For example, the second materials included on the interior surface of the cover accessory 502 can be selected to improve grip between the cover accessory 502 and the boat 506, and the second materials included on the exterior surface of the cover accessory 502 can be selected to improve grip between the cover accessory 502 and the cover 504.

In FIG. 5B, a cover 504 is installed on the boat 506 over the cover accessory 502. The cover 504 can be a conventional cover, and can at least partially overlap the cover accessory 502. The cover 504 and/or the cover accessory 502 can be configured such that the cover 504 overlaps a majority of the cover accessory 502 (e.g., at least about 95%, about 90%, about 80%, about 75%, or the like) in order to maximize grip between the cover 504 and the cover accessory 502. The cover 504 and/or the cover accessory 502 can be configured such that the cover 504 does not extend past the cover accessory 502, which can prevent damage to the boat 506 caused by the cover 504 flapping, rubbing, or otherwise moving relative to the boat 506. However, the cover 504 and the cover accessory 502 can be provided with any suitable overlap.

The cover accessory 502 can be provided to increase grip between the cover 504 and the boat 506. By providing the cover accessory 502, a conventional cover can be used on the boat, without requiring the cover to be replaced. The increased grip provided by the cover accessory 502 prevents the cover 504 from flapping, rubbing, or otherwise moving relative to the boat 506, and prevents the cover 504 from damaging the boat 506.

The above-described examples have been described in a particular context, namely, in the context of covers that are used in the transportation and storage of boats. However, a person of skill in the art will understand that the teachings of the present disclosure can be applied in other contexts. For example, non-slip materials can be used in any contexts in which an object is covered by a cover. This can include covers that are used for transportation or storage of other personal watercraft, automobiles, travel trailers, recreational vehicles, bicycles, other vehicles, air conditioner units, grills, fire pits, hot tubs, other home items, industrial items, other personal items, or any other objects. The covers of the present disclosure can be particularly useful in covering objects in situations where the covers and the objects are subjected to windy conditions, such as during transportation of the objects, or in areas with high winds.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A boat cover comprising:
a first fabric material defining an exterior surface of a boat cover and at least partially defining an interior surface of the boat cover; and
a second material coupled to the first fabric material, the second material is a non-slip material different from the first fabric material, the second material extending at least partially around a perimeter of the first fabric material, the second material at least partially defining the interior surface of the boat cover.

2. The boat cover of claim 1, wherein the second material comprises rubber or silicone.

3. The boat cover of claim 1, wherein the second material is coupled to the first fabric material by sewing, bonding, or an adhesive.

4. The boat cover of claim 1, wherein the first fabric material comprises a water resistant, breathable material.

5. The boat cover of claim 1, wherein the second material is discontinuous around the perimeter of the first fabric material.

6. The boat cover of claim 1, wherein the second material is continuous around the perimeter of the first fabric material.

7. The boat cover of claim 6, wherein:
the first fabric material defines a corner region and an edge region adjacent to the corner region;
the corner region is free from the second material; and
the second material extends along the edge region.

8. The boat cover of claim 1, further comprising a third material coupled to the first fabric material, the third material comprising a soft material different from the first fabric material and the second material, the third material at least partially defining the interior surface of the boat cover.

9. The boat cover of claim 1, further comprising a vent disposed in the first fabric material, wherein the vent is operable to create a pressure differential between an interior and an exterior of the boat cover when air moves over the boat cover.

10. The boat cover of claim 1, further comprising an elastic material coupled to the first fabric material and extending at least partially around a perimeter of the first fabric material.

11. The boat cover of claim 1, further comprising a strap coupled to the first fabric material, the strap being configured to apply pressure from the first fabric material to the second material.

12. A cover comprising:
a first fabric material defining an outer surface of a cover, the first fabric material comprising a waterproof, breathable material; and
a second material bonded to the first fabric material, the second material comprising a non-slip material, the second material at least partially defining an inner surface of the cover, the second material at least partially surrounding the first fabric material on the inner surface of the cover.

13. The cover of claim 12, wherein the second material is bonded to the first fabric material by an adhesive or a bonding agent.

14. The cover of claim 12, wherein the second material comprises silicone or rubber.

15. The cover of claim 12, further comprising a third material coupled to the first fabric material, the third material at least partially defining the inner surface of the cover, the third material comprising fleece, flocking, felt, or flannel.

16. The cover of claim 12, wherein the second material extends continuously or discontinuously along a perimeter of the first fabric material.

17. An accessory for a cover comprising:
a first material configured to contact a boat; and
a second material bonded to the first material, the second material configured to contact a boat cover;
wherein:
the first material comprises a non-slip material; and
the second material comprises a breathable, waterproof material.

18. The accessory of claim 17, wherein the first material and the second material form an annular shape.

19. The accessory of claim 17, wherein:
the first material comprises a silicone or rubber material; and
the second material comprises a fabric formed from polyester, acrylic, or nylon.

20. The accessory of claim 17, further comprising a third material bonded to the second material opposite the first material, wherein:
the first material is a first non-slip material;
the third material is configured to contact the boat cover; and
the third material comprises a second non-slip material.
